(19) United States
(12) Patent Application Publication
(10) Pub. No.: US 2020/0311604 A1
(43) Pub. Date: Oct. 1, 2020

(54) ACCELERATED DATA ACCESS FOR TRAINING

(71) Applicant: KONINKLIJKE PHILIPS N.V., EINDHOVEN (NL)

(72) Inventor: BINYAM GEBREKIDAN GEBRE, EINDHOVEN (NL)

(21) Appl. No.: 16/756,498

(22) PCT Filed: Dec. 18, 2018
(86) PCT No.: PCT/EP2018/085398

§ 371 Date: Apr. 16, 2020

Related U.S. Application Data
(60) Provisional application No. 62/609,414, filed on Dec. 22, 2017.

(51) Int. Cl. G06N 20/00

(52) U.S. Cl. CPC G06N 20/00; G11B 5/012

(57) ABSTRACT

Methods and systems for storing and accessing training example data for a machine learning procedure. The systems and methods described pre-process data to store it in a non-transient memory in a random order. During training, a set of the data is retrieved and stored in a random access memory. One or more subsets of the data may then be retrieved from the random access memory and used to train a machine learning model.

### TECHNICAL FIELD

Embodiments described herein generally relate to systems and methods for executing machine learning procedures and, more particularly but not exclusively, to systems and methods for accessing data for training machine learning procedures.

### BACKGROUND

Deep learning is a powerful technology for training computers to perform tasks based on examples. In general, the performance of the machine learning model associated with the task improves with more training examples and with more training using those examples.

However, more examples and more training using those examples also means moving large data sets multiple times from secondary storage to CPUs and GPUs. Delays introduced by these transfers can significantly slow down the training of deep neural networks or other types of machine learning models.

A need exists, therefore, for systems and methods for training example data for a machine learning procedure that overcome the disadvantages of existing techniques.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a method for accessing training example data for a machine learning procedure. The method includes sequentially retrieving a first set of stored training examples from a non-transient memory, storing the retrieved first set of training examples in a random access memory, randomly retrieving a first subset of the first set of training examples from the random access memory, and applying a machine learning procedure to the retrieved first subset to train a machine learning model.

In some embodiments, the method further includes sequentially storing the plurality of training examples in a random order in the non-transient memory prior to their sequential retrieval.

In some embodiments, the method further includes randomly retrieving at least one second subset of the first set of training examples from the random access memory, and applying the machine learning procedure to the at least one second retrieved subset to train the machine learning model.

In some embodiments, the method further includes sequentially retrieving a second set of the stored training examples from the non-transient memory, storing the retrieved second set of training examples in the random access memory, randomly retrieving a first subset of the second set of training examples from the random access memory, and applying the machine learning procedure to the first subset of the second set of training examples to train the machine learning model. In some embodiments, the second set of the stored training examples is adjacent to the first set of stored training examples in the non-transient memory.

In some embodiments, the non-transient memory is a hard disk.

In some embodiments, the stored training examples are part of a hierarchical data format (hdf) dataset.

In some embodiments, sequentially retrieving a first set of stored training examples and randomly retrieving a first subset of the first set of training examples are repeated, and randomly retrieving a first subset is performed more frequently than sequentially retrieving a first set of stored training examples.

In some embodiments, sequentially retrieving a first set of stored training examples is repeated, and randomly retrieving a first subset is performed while sequentially retrieving a first set of stored training examples.

According to another aspect, embodiments relate to a system for accessing training example data for a machine learning procedure. The system includes a non-transient memory storing a plurality of training examples, a random access memory configured to store a first set of the stored training examples sequentially retrieved from the non-transient memory, and a processor executing instructions stored on a memory to apply a machine learning procedure to a first subset of the first set of stored training examples to train a machine learning model.

In some embodiments, the plurality of training examples are sequentially stored in a random order in the non-transient memory prior to their sequential retrieval.

In some embodiments, the processor is further configured to apply the machine learning procedure to at least one second retrieved subset of the first set of training examples from the random access memory to train the machine learning model.

In some embodiments, the random access memory is further configured to store a second set of the stored training examples sequentially retrieved from the non-transient memory, and the processor is further configured to apply the machine learning procedure to a first subset of the stored second set of training examples to train the machine learning model. In some embodiments, the second set of the stored training examples is adjacent to the first set of the stored training examples in the non-transient memory.

In some embodiments, the non-transient memory is a hard disk.

In some embodiments, sets of the stored training examples and subsets of the sets of the stored training examples are periodically retrieved, and the subsets are retrieved more frequently than the sets of training examples.

In some embodiments, the first subset is randomly retrieved while the first set of stored training examples is sequentially retrieved.

According to yet another aspect, embodiments relate to a computer readable storage medium containing computer-executable instructions for accessing training example data for a machine learning procedure. The medium includes computer-executable instructions for sequentially retrieving a first set of stored training examples from a non-transient memory, computer-executable instructions for storing the retrieved first set of training examples in a random access memory, computer-executable instructions for randomly retrieving a first subset of the first set of training examples from the random access memory, and computer-executable instructions for applying a machine learning procedure to the first subset to train a machine learning model.

In some embodiments, the instructions are part of at least one driver for accessing at least one of the non-transient memory and the random access memory.

In some embodiments, the instructions for sequentially retrieving the first set of stored training examples are part of a set of instructions implementing a protocol for communication with a remote device including the non-transient memory.

### BRIEF DESCRIPTION OF DRAWINGS

Non-limiting and non-exhaustive embodiments of the embodiments herein are described with reference to the following figures, wherein like reference numerals refer to like parts throughout the various views unless otherwise specified.

FIG. 1 illustrates a system for accessing training example data for a machine learning procedure in accordance with one embodiment;

FIG. 2 illustrates a workflow of various components for accessing training example data for a machine learning procedure in accordance with one embodiment;

FIG. 3 depicts a flowchart of a method for accessing training example data for a machine learning procedure in accordance with one embodiment;

FIG. 4 depicts a flowchart of a method for accessing training example data for a machine learning procedure in accordance with another embodiment; and

FIG. 5 depicts flowchart of a method for accessing training example data for a machine learning procedure in accordance with yet another embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Data reading for training neural networks generally happens iteratively and repeatedly in batches (e.g., of 16, 32, or 64 examples). Moreover, this reading occurs over hundreds to thousands of epochs (an epoch is a complete pass through all training examples). This can in total amount to tens or hundreds of gigabytes and, in some cases, even terabytes of data.

As discussed above, reading data multiple times from secondary storage to provide to processing units significantly slows machine learning model training. This slowness can be further exacerbated by the slow nature of storage devices (e.g., hard disks), limited network bandwidth, or simply due to the sheer size of the datasets.

Existing techniques to speed up read access include using faster, more expensive storage devices such as SSDs and having high network bandwidth. However, these solutions are expensive and may not scale for certain large datasets.

It is known that machine learning models learn more effectively from different batches of training examples than from repeated exposure to batches of examples that it has seen before. Additionally, repeated trainings using small batches of examples is more effective than less frequent trainings using large batches of examples.

Training machine learning models is also more effective when the training examples come in a random order and in small portions (e.g., sets of 16, 32, or 64 examples). On the other hand, data reading from non-transient memories like hard disks is much faster when the data is accessed sequentially and in large portions.

However, accessing data from disk in a way to satisfy the random order used in model training is very slow as the read-write head has to move physically to different locations to read the random training data. That is, moving the read-write head to repeatedly read a small random portion of data is time consuming as it requires a large number of disk accesses to read all of the data.

Speeding up the training of machine learning models therefore requires (1) efficiently moving data from storage devices (e.g., hard disks) to computation devices like CPUs and GPUs; (2) efficiently performing computations on the computation devices; (3) performing both operations in parallel to the extent possible; and (4) speeding up the slower of the two operations. That is, although computational devices like GPUs are becoming increasingly fast, there is no value in having faster processing units if data cannot be supplied to them quickly enough.

Features of various embodiments address these requirements in part by specifying how data should be stored to prepare it for faster reading. In accordance with various embodiments, a dataset of training examples is pre-processed and stored in a random order in a non-transient memory. During subsequent access, a large set of the stored, randomly-ordered data is transferred to a random access memory cache. The cached data can then be used by a machine learning module to generate small, random subsets to train a machine learning model.

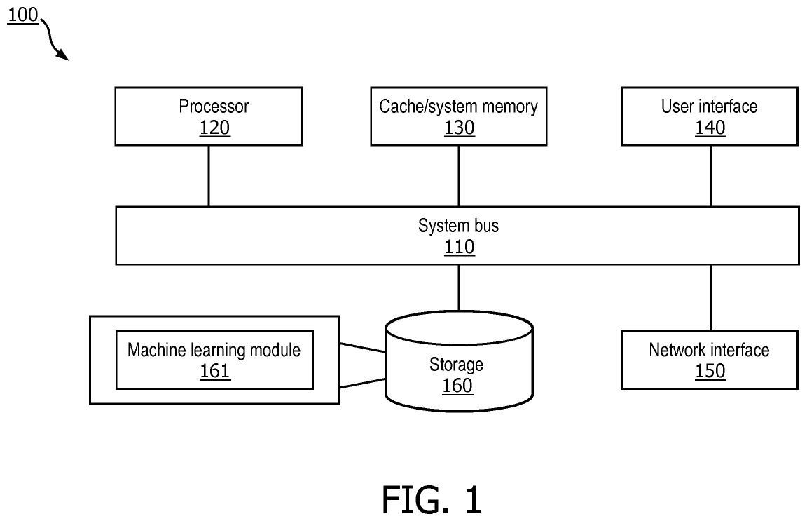

FIG. 1 illustrates a system for accessing training example data for a machine learning procedure in accordance with one embodiment. The system 100 may include a processor 120, memory 130, a user interface 140, a network interface 150, and storage 160 interconnected via one or more system buses 110. It will be understood that FIG. 1 constitutes, in some respects, an abstraction and that the actual organization of the system 100 and the components thereof may differ from what is illustrated.

Referring back to FIG. 1, the processor 120 may be any hardware device capable of executing instructions stored on memory 130 and/or in storage 160, or otherwise any hardware device capable of processing data. As such, the processor 120 may include a microprocessor, field programmable gate array (FPGA), application-specific integrated circuit (ASIC), or other similar devices.

The memory 130 may include various non-transient memories such as, for example L1, L2, or L3 cache or system memory. As such, the memory 130 may include static random access memory (SRAM), dynamic RAM (DRAM), flash memory, read only memory (ROM), or other similar memory devices and configurations.

The user interface 140 may include one or more devices for enabling communication with a user. For example, the user interface 140 may include a display, a mouse, and a keyboard for receiving user commands. In some embodiments, the user interface 140 may include a command line interface or graphical user interface that may be presented to a remote terminal via the network interface 150. The user interface 140 may execute on a user device such as a PC, laptop, tablet, mobile device, or the like, and may enable a user to input parameters regarding a machine learning model, for example.

The network interface 150 may include one or more devices for enabling communication with other remote devices. For example, the network interface 150 may include a network interface card (NIC) configured to communicate according to the Ethernet protocol. Additionally, the network interface 150 may implement a TCP/IP stack for communication according to the TCP/IP protocols. Various alternative or additional hardware or configurations for the network interface 150 will be apparent.

The storage 160 may include one or more machine-readable storage media such as read-only memory (ROM), random-access memory (RAM), magnetic disk storage media, optical storage media, flash-memory devices, or similar storage media. In various embodiments, the storage 160 may store instructions for execution by the processor 120 or data upon which the processor 120 may operate.

For example, the storage 160 may include a machine learning module 161 to apply a machine learning procedure to the retrieved data to train a model. The model may be any type machine learning model such as deep learning models, recurrent neural networks, convolutional neural networks, or the like.

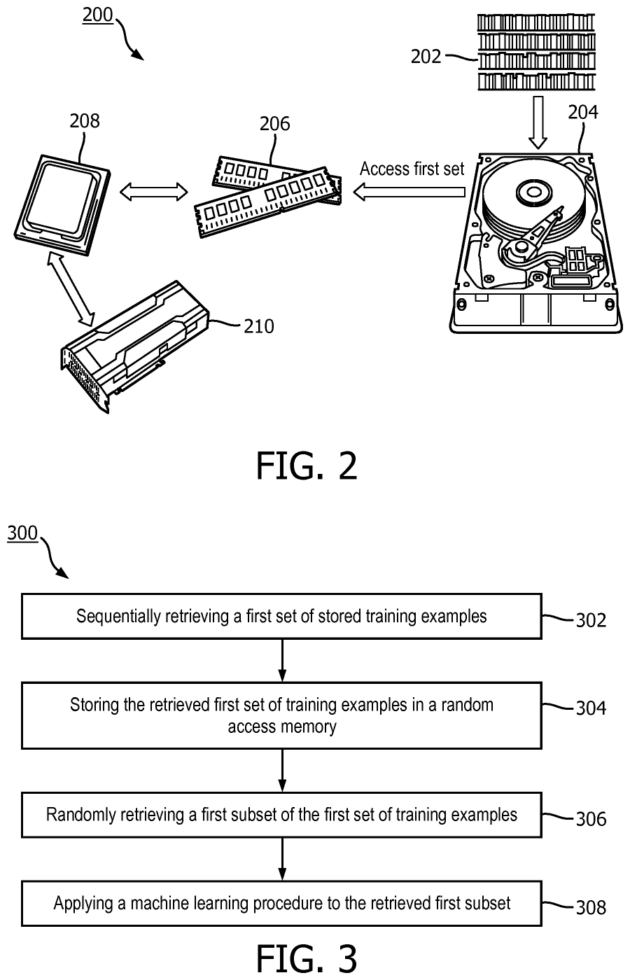

FIG. 2 illustrates a workflow 200 of various components for accessing training example data for a machine learning procedure in accordance with one embodiment. Randomized data 202 comprising training examples may be stored in a non-transient, contiguous memory space 204 such as a hard disk.

In some embodiments, the randomized training example data 202 may include hierarchical data format (e.g., HDF5) datasets, which are n-dimensional arrays that are stored on disk. They have a type and a shape, and support random access when needed. They also have a mechanism for chunked storage (i.e., a mechanism for storing related bytes adjacent to each other on the hard disk).

The training data 202 may have been previously randomized in a pre-processing step by any suitable device such as the processor 120 of FIG. 1. This randomization step therefore processes and stores the data 202 in a random order in the non-transient, contiguous memory space 204.

This data randomization step adds overhead and consumes time. However, it is only done once and is more than offset by the reduction in access time it enables for repeated, subsequent accesses.

The dataset 202 may be divided into a plurality of portions, wherein the portions are placed in the random order. The size of the portions may vary and may depend on the overall size of the dataset and various operational parameters.

A portion may include a single entry of data or multiple entries of data, for example. The size of the portions may vary as long as the features of various embodiments described herein may be accomplished.

During data reading, a first set of training example data is sequentially retrieved from the non-transient memory space 204. This access starts at a random location and the set is read sequentially. The first set of retrieved training example data is relatively large and is stored in a read-ahead random access memory (RAM) cache 206. Accordingly, at this point the RAM 206 contains a relatively large set of training data that is stored in a random order because the data was randomized prior to its storage.

CPUs 208 and/or GPUs 210 (or any other applicable device such as the processor 120 of FIG. 1) can then access a random subset of the data stored in the RAM 206 and perform an applicable machine learning procedure thereon. The CPUs 208 and/or the GPUs 210 may retrieve these subsets from the RAM 206 frequently and apply the machine learning procedure to these subsets to train a machine learning model such as a neural network.

In some embodiments, once all the data stored in RAM 206 has been analyzed, a second set of data may be retrieved from the non-transient contiguous memory space 204 and the process is repeated. In some embodiments, the training process may not end until the entire dataset is analyzed and used for training hundreds or thousands of times.

It is worth noting the importance of randomizing the data and storing it in a contiguous memory space. Without it, there may be two issues. For one, filling the RAM 206 with a large set of data would be a slow process for each access as there is no guarantee that the default data storage would be in a contiguous memory space. Second, even if the default storage were in a contiguous memory space to begin with, it would not necessarily be in a random order as required by deep learning training procedures.

FIG. 3 depicts a flowchart of a method 300 for accessing training example data for a machine learning procedure. Step 302 involves sequentially retrieving a first set of stored training examples from a non-transient memory. The non-transient memory may be similar to the non-transient memory space 204 of FIG. 2, for example. As discussed above, the first set of the stored training examples may include a plurality of training examples in a random order.

Step 304 involves storing the retrieved first set of training examples in a random access memory. The random access memory may be similar to the read ahead RAM cache 206 of FIG. 2, for example. Steps 302 and 304 may generally be performed infrequently.

Step 306 involves randomly retrieving a first subset of the first set of training examples from the random access memory. Step 306 may involve a CPU and/or a GPU retrieving a random subset from the random access memory.

Step 308 involves applying a machine learning procedure to the retrieved first subset to train a machine learning model. This step may be performed by a CPU and/or a GPU such as the CPU 208 or GPU 210 of FIG. 2. The machine learning model may be a neural network, for example, or any other machine learning model known to one of ordinary skill.

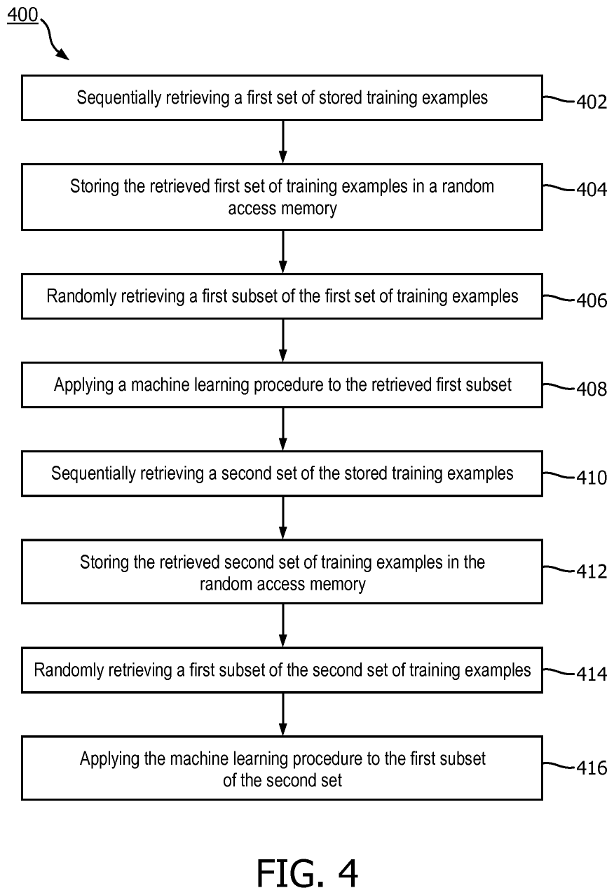

FIG. 4 depicts a flowchart of a method 400 for accessing training example data for a machine learning procedure in accordance with another embodiment. Steps 402-408 of FIG. 4 are similar to steps 302-308, respectively, of FIG. 3 and are not repeated here.

Step 410 involves sequentially retrieving a second set of the stored training examples from the non-transient memory. Once the first set of training data has been used for training a machine learning model, a second set of stored training examples may be retrieved from the non-transient memory. The second set of the stored training examples may be adjacent to the first set of stored training examples in the non-transient memory.

Step 412 involves storing the retrieved second set of training examples in the random access memory. As mentioned above, the random access memory may be similar to the read ahead random access memory cache 206 of FIG. 2.

Step 414 involves randomly retrieving a first subset of the second set of training examples from the random access memory. The first subset of the second set of training data is of course also already in a random order. Step 414 may be performed by a CPU and/or a GPU such as the CPU 208 or GPU 210 of FIG. 2.

Step 416 involves applying the machine learning procedure to the first subset of the second set of training examples to train the machine learning model. As in the method 300 of FIG. 3, the machine learning model may be a neural network or any other model known to one of ordinary skill.

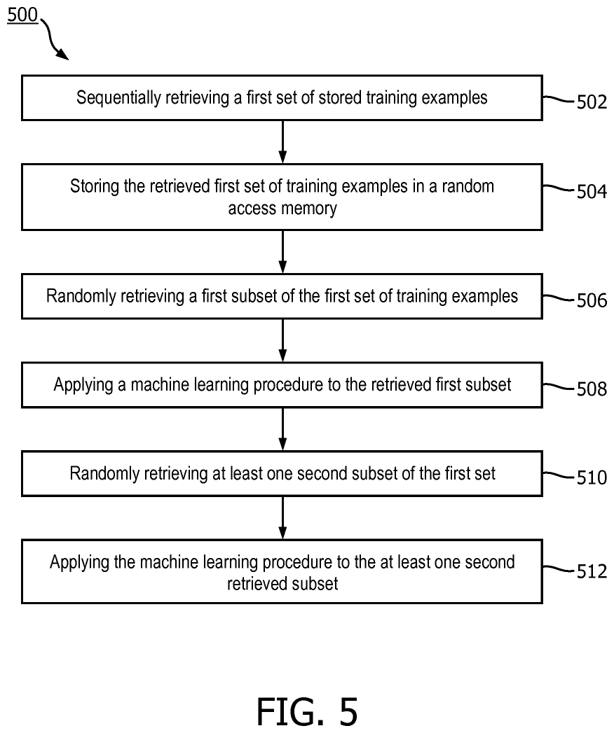

FIG. 5 depicts a flowchart of a method 500 for accessing training example data in accordance with yet another embodiment. Steps 502-508 are similar to steps 302-308, respectively, of FIG. 3 and are not repeated here.

Step 510 involves randomly retrieving at least one second subset of the first set of training examples from the random access memory. That is, after the CPU and/or GPU applies the machine learning procedure to the first subset, the processing unit may randomly select another subset of data from the training example data stored in the random access memory and continue the training process.

Step 512 involves applying the machine learning procedure to the at least one second subset of data from the training example data. Accordingly, the machine learning procedure is applied to multiple subsets of data.

The steps of the methods 300, 400, and 500 of FIGS. 3, 4, and 5, respectively may be iterated or otherwise repeated to complete the training of a machine learning model. For example, the steps of retrieving a first set of stored training examples and randomly retrieving a first subset of the first set of training examples may be repeated. That is, multiple sets of stored training examples may be sequentially retrieved for storage in the random access memory, and multiple subsets of each of the sets of stored training examples may be retrieved for training the machine learning model.

Additionally, the step of retrieving a subset may be performed more frequently than the step of retrieving a set of the training data from the non-transient memory. Additionally or alternatively, the step(s) of randomly retrieving the set(s) of training examples from the non-transient memory may be performed while retrieving the subsets of training examples already stored in the random access memory.

In some embodiments with a sufficiently large random access memory, a set of training examples retrieved from the hard disk may be stored in a first portion of the random access memory while subsets of stored training examples are retrieved from a second portion of the random access memory already storing training examples previously retrieved from disk. In these embodiments, the step of selecting subsets of stored training examples may switch between the different portions of the random access memory storing different sets of training examples retrieved from disk.

Features of various embodiments described herein may be implemented in a variety of applications that would benefit from improved machine learning. For example, applications such as pattern recognition, imagery analysis, facial recognition, data mining, sequence recognition, medical diagnosis applications, filtering applications, or the like may benefit from the data access methods and systems described herein. Although the present disclosure primarily discusses neural networks, other types of machine learning models may benefit from the features of various embodiments described herein.

The features of various embodiments described herein may be embodied or otherwise implemented in a variety of ways. The methods and systems described herein may be implemented in machine learning/training software, operating systems, or drivers for the storage and memory devices.

In embodiments in which the methods and systems are implemented as part of an operating system or drivers, the operating system or drivers may define a new access mode used for training the machine learning model. The machine learning model or associated software may then use this access mode during training.

In some embodiments, one or more drivers may include instructions for accessing at least one of the non-transient memory and the random access memory. In some embodiments, the non-transient memory may be accessible by a plurality of users. The applicable software, operating system, or driver(s) may therefore include instructions for implementing a protocol to enable communication between the non-transient memory and a remote device. In this case, the systems and methods described herein enable more processes to access the memory faster, as each process accesses the data a fewer number of times. Accordingly, this leaves the disk read-write heads free for other processes.

The features of various embodiments described herein may also be implemented in distributed computing environments. In these embodiments, the non-transient memory may be a network storage device or a cloud storage device. Coupled with the scenarios in which the methods or systems are implemented on operating systems or drivers, the communications protocol itself may define an access mode for use by the machine learning software.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for accessing training example data for a machine learning procedure, the method comprising:
sequentially retrieving a first set of stored training examples from a non-transient memory;
storing the retrieved first set of training examples in a random access memory;
randomly retrieving a first subset of the first set of training examples from the random access memory; and
applying a machine learning procedure to the retrieved first subset to train a machine learning model.

2. The method of claim 1 further comprising sequentially storing the plurality of training examples in a random order in the non-transient memory prior to their sequential retrieval.

3. The method of claim 1 further comprising:
randomly retrieving at least one second subset of the first set of training examples from the random access memory; and
applying the machine learning procedure to the at least one second retrieved subset to train the machine learning model.

4. The method of claim 1 further comprising:
sequentially retrieving a second set of the stored training examples from the non-transient memory;
storing the retrieved second set of training examples in the random access memory;
randomly retrieving a first subset of the second set of training examples from the random access memory; and
applying the machine learning procedure to the first subset of the second set of training examples to train the machine learning model.

5. The method of claim 4, wherein the second set of the stored training examples is adjacent to the first set of stored training examples in the non-transient memory.

6. The method of claim 1 wherein the non-transient memory is a hard disk.

7. The method of claim 1 wherein the stored training examples are part of a hierarchical data format (hdf) dataset.

8. The method of claim 1 wherein sequentially retrieving a first set of stored training examples and randomly retrieving a first subset of the first set of training examples are repeated, and randomly retrieving a first subset is performed more frequently than sequentially retrieving a first set of stored training examples.

9. The method of claim 1 wherein sequentially retrieving a first set of stored training examples is repeated, and randomly retrieving a first subset is performed while sequentially retrieving a first set of stored training examples.

10. A system for accessing training example data for a machine learning procedure, the system comprising:
a non-transient memory storing a plurality of training examples;
a random access memory configured to store a first set of the stored training examples sequentially retrieved from the non-transient memory; and
a processor executing instructions stored on a memory to apply a machine learning procedure to a first subset of the first set of stored training examples to train a machine learning model.

11. The system of claim 10 wherein the plurality of training examples are sequentially stored in a random order in the non-transient memory prior to their sequential retrieval.

12. The system of claim 10 wherein the processor is further configured to apply the machine learning procedure to at least one second retrieved subset of the first set of training examples from the random access memory to train the machine learning model.

13. The system of claim 10 wherein the random access memory is further configured to store a second set of the stored training examples sequentially retrieved from the non-transient memory, and the processor is further configured to apply the machine learning procedure to a first subset of the stored second set of training examples to train the machine learning model.

14. The system of claim 13 wherein the second set of the stored training examples is adjacent to the first set of the stored training examples in the non-transient memory.

15. The system of claim 10 wherein the non-transient memory is a hard disk.

16. The system of claim 10 wherein sets of the stored training examples and subsets of the sets of the stored training examples are periodically retrieved, and the subsets are retrieved more frequently than the sets of training examples.

17. The system of claim 10 wherein the first subset is randomly retrieved while the first set of stored training examples is sequentially retrieved.

18. A computer readable storage medium containing computer-executable instructions for accessing training example data for a machine learning procedure, the medium comprising:
computer-executable instructions for sequentially retrieving a first set of stored training examples from a non-transient memory;
computer-executable instructions for storing the retrieved first set of training examples in a random access memory;
computer-executable instructions for randomly retrieving a first subset of the first set of training examples from the random access memory; and
computer-executable instructions for applying a machine learning procedure to the first subset to train a machine learning model.

19. The computer readable storage medium of claim 18 wherein the instructions are part of at least one driver for accessing at least one of the non-transient memory and the random access memory.

20. The computer readable storage medium of claim 18 wherein the instructions for sequentially retrieving the first set of stored training examples are part of a set of instructions implementing a protocol for communication with a remote device including the non-transient memory.
